(19) United States
(12) Patent Application Publication
(10) Pub. No.: US 2008/0023262 A1
(43) Pub. Date: Jan. 31, 2008

(54) Air-intake apparatus

(75) Inventors: Kazuhiro Hayashi, Nishikamo-gun (JP); Toshiaki Nakayama, Nishikamo-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/806,900

(22) Filed: Jun. 5, 2007

(30) Foreign Application Priority Data
Jul. 28, 2006 (JP) 2006-206209

(51) Int. Cl. F02M 35/12; F02M 35/00

(52) U.S. Cl. 181/229

(57) ABSTRACT

An air-intake apparatus includes an inner pipe member and an outer pipe member. The inner pipe member defines an intake passage that connects an inlet and a surge tank. Air is drawn into the inlet. A diameter of the inner pipe member gradually increases when the inner pipe member extends toward a surge tank-side end portion of the inner pipe member. The outer pipe member covers an outer circumferential side of the inner pipe member and defines a resonator between the outer pipe member and the inner pipe member. The resonator communicates with the intake passage.

### CROSS REFERENCE TO RELATED APPLICATION

This application is based on and incorporates herein by reference Japanese Patent Application No. 2006-206209 filed on Jul. 28, 2006.

### BACKGROUND OF THE INVENTION

1. Field of the Invention:

The present invention relates to an air-intake apparatus.

2. Description of Related Art:

In order to reduce an intake air noise of an internal combustion engine of an automobile, it is known that, for example, a resonator having an inner volume chamber is provided at a part of an intake passage. As the resonator, a slit resonator in JP-U-5-38352, and a fixed resonator in JP-U-56-113163, for example, are known. In the slit resonator of JP-U-5-38352, a slit or a hole is formed on an inner circumferential side-piping member, which forms an intake passage. By covering the slit or hole with an outer circumferential side-piping member, the resonator, which is communicated with the intake passage through the slit or hole, is formed on an outer circumferential side of the intake passage. Since the slit resonator involves slits or holes, it has a plurality of resonance frequencies. Accordingly, the intake air noise can be reduced in a broad frequency range.

In the case of the fixed resonator of JP-U-56-113163, a resonator is provided, as the inner volume chamber communicated with the intake passage. The fixed resonator is communicated with an intake air chamber through a single communicating passage. Accordingly, although the intake air noise is reduced at only one resonance frequency, volume of the resonator is large, and intake air noise reduction performance is high.

However, in both cases of the above resonators, a member needs to be provided around the piping member that forms the intake passage in order to form the resonator. As a result, a projection part increases around the piping member, thereby causing upsizing and difficulty in installation in a peripheral part around the internal combustion engine. The fixed resonator only reduces the intake air noise of a single frequency, and the slit resonator only reduces the intake air noises having a plurality of predetermined resonance frequencies. Hence, reduction in the intake air noises in a broader range is difficult.

### SUMMARY OF THE INVENTION

The present invention addresses the above disadvantages. Thus, it is an objective of the present invention to provide an air-intake apparatus, which reduces an intake air noise in a broad frequency range without causing upsizing of the air-intake apparatus, and is easily installed.

To achieve the objective of the present invention, there is provided an air-intake apparatus including an inner pipe member and an outer pipe member. The inner pipe member defines an intake passage that connects an inlet and a surge tank. Air is drawn into the inlet. A diameter of the inner pipe member gradually increases when the inner pipe member extends toward a surge tank-side end portion of the inner pipe member. The surge tank-side end portion is connected to the surge tank. The outer pipe member covers an outer circumferential side of the inner pipe member and defines a resonator between the outer pipe member and the inner pipe member. The resonator communicates with the intake passage.

### BRIEF DESCRIPTION OF THE DRAWINGS

The invention, together with additional objectives, features and advantages thereof, will be best understood from the following description, the appended claims and the accompanying drawings in which:

FIG. 1 is a schematic cross-sectional view of an air-intake system, to which an air-intake apparatus according to a first embodiment of the present invention is applied;

FIG. 2 is a schematic cross-sectional view of an intake pipe portion of the air-intake apparatus according to the first embodiment;

FIG. 3 is a schematic cross-sectional view of an air-intake system, to which an air-intake apparatus according to a second embodiment of the present invention is applied; and

FIG. 4 is a schematic cross-sectional view of an air-intake system, to which an air-intake apparatus according to a third embodiment of the present invention is applied.

### DETAILED DESCRIPTION OF THE INVENTION

Embodiments of the present invention are described below with reference to drawings. In each of the embodiments, the same numerals are used to indicate substantially the same components to omit their descriptions.

### First Embodiment

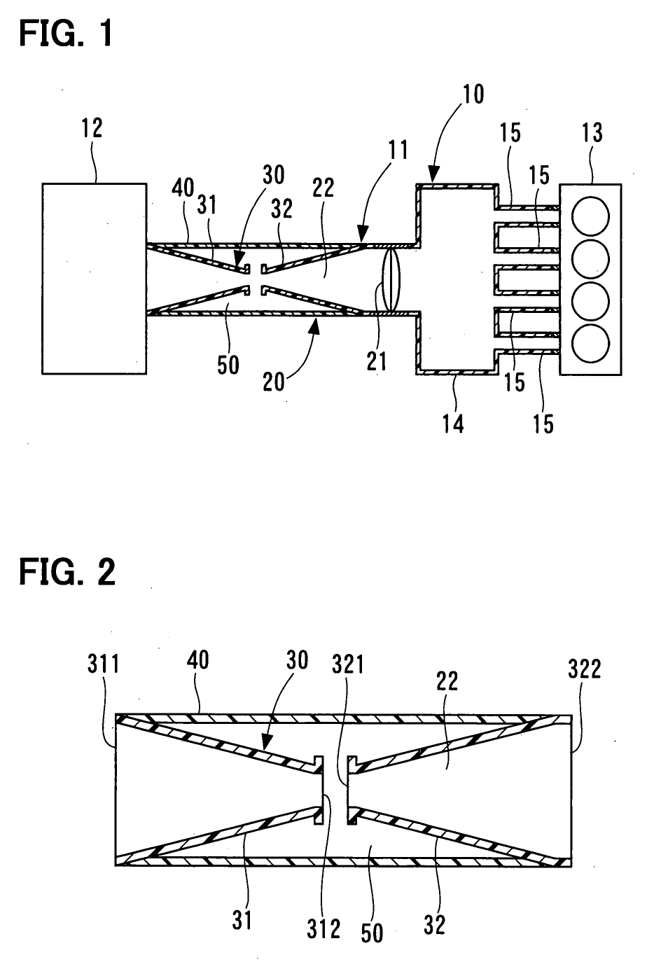

FIG. 1 shows an air-intake system, to which an air-intake apparatus according to a first embodiment of the present invention is applied.

As shown in FIG. 1, an air-intake system 10 includes an air-intake apparatus 11, an air cleaner 12, and a gasoline engine (hereafter engine) 13 as an internal combustion engine. The air-intake apparatus 11 has a surge tank 14. Intake manifolds 15 branch from the surge tank 14. The intake manifolds 15 branch out according to the number of cylinders of the engine 13, and each of the intake manifolds 15 is connected to corresponding one of the cylinders.

The air cleaner 12 is placed at an end portion of the air-intake apparatus 11, which is opposite to the other end portion, at which the engine 13 is placed. The air cleaner 12 receives an air cleaner element (not shown) inside the air cleaner 12. When air drawn into the engine 13 flows through the air cleaner 12, a foreign object is removed from the air. Air to be drawn into the engine 13 is drawn from the air cleaner 12. Accordingly, the air cleaner 12 serves as “an inlet”.

An intake pipe portion 20 is provided between the surge tank 14 of the air-intake apparatus 11 and the air cleaner 12. The intake pipe portion 20 has a throttle 21. The throttle 21 opens and closes an intake passage 22 formed from the intake pipe portion 20 to regulate a flow of intake air flowing in the intake passage 22.

The intake pipe portion 20 has an inner pipe member 30 and an outer pipe member 40. The inner pipe member 30 has a first inner pipe member 31 and a second inner pipe member 32. As shown in FIG. 2, an inside diameter and an outside diameter of the first inner pipe member 31 gradually decrease as the first inner pipe member 31 extends from an end portion 311 on an air cleaner 12-side toward a surge tank 14-side. In other words, the first inner pipe member 31 is formed like a truncated cone in a tubular manner. An inside diameter and an outside diameter of the second inner pipe member 32 gradually increase as the second inner pipe member 32 extends from an end portion 321 on the air cleaner 12-side toward the surge tank 14-side. In other words, the second inner pipe member 32 is formed like a truncated cone in a tubular manner, similar to the first inner pipe member 31. The intake passage 22 is formed on inner circumferential sides of the first inner pipe member 31 and the second inner pipe member 32. The intake passage 22 connects the air cleaner 12 and the surge tank 14. Air, which flows through the air cleaner 12, flows into the surge tank 14 via the intake passage 22. The air, which flows into the surge tank 14, is supplied to each of the cylinders of the engine 13 through the intake manifolds 15.

By forming the first inner pipe member 31 like a truncated cone in a tubular manner, the first inner pipe member 31 has its maximum inside and outside diameters at the end portion 311 on the air cleaner 12-side. Thus, the first inner pipe member 31 has the end portion 311, which is on a large-diameter side of the first inner pipe member 31, on the air cleaner 12-side, and an end portion 312, which is on a small-diameter side of the first inner pipe member 31, on the surge tank 14-side. As well, by forming the second inner pipe member 32 like a truncated cone in a tubular manner, the second inner pipe member 32 has its maximum inside and outside diameters at an end portion 322 on the surge tank 14-side. Thus, the second inner pipe member 32 has the end portion 321, which is on a small-diameter side of the second inner pipe member 32, on the air cleaner 12-side, and the end portion 322, which is on a large-diameter side of the second inner pipe member 32, on the surge tank 14-side. In the first embodiment, the first inner pipe member 31 and the second inner pipe member 32 are formed symmetrically, so that their respective maximum and minimum inside diameters and outside diameters, and entire lengths are approximately the same. The end portion 312 of the first inner pipe member 31 on the surge tank 14-side is opposed to the end portion 321 of the second inner pipe member 32 on the air cleaner 12-side with a predetermined gap therebetween. Accordingly, the first inner pipe member 31 and the second inner pipe member 32 are arranged such that the end portion 312, which is on the small-diameter side of the first inner pipe member 31 is opposed to the end portion 321, which is on the small-diameter side of the second inner pipe member 32.

The outer pipe member 40 is provided on an outer circumferential side of the first inner pipe member 31 and the second inner pipe member 32. The outer pipe member 40 receives the first inner pipe member 31 and the second inner pipe member 32 on its inner circumferential side. The intake pipe portion 20 is made of resin. Thus, the intake pipe portion 20 may be formed, for example, in such a manner that the first inner pipe member 31 and the second inner pipe member 32 are inserted into the inner circumferential side of the outer pipe member 40 and then their joining parts are fusion-bonded together, or that halved members, which are cut along a central axis of the intake pipe portion 20 and have symmetrical shapes, are formed and then they are joined together by fusion-bonding or the like. In addition, the intake pipe portion 20 may be formed by injection-molding the inner pipe member 30 and the outer pipe member 40 integrally.

By forming the second inner pipe member 32 in a tubular manner like a truncated cone, the diameter of which increases from the air cleaner 12-side toward the surge tank 14-side, the second inner pipe member 32 serves as a diffuser that diffuses a flow of intake air. Thus, a diffuser effect is produced in a flow of air flowing in the intake passage 22 formed on an inner circumferential side of the second inner pipe member 32. As a result, a sound of intake air, which flows in the intake passage 22, is reduced by the diffuser effect when the intake air flows through the second inner pipe member 32.

By forming the first inner pipe member 31 in a tubular manner like a truncated cone, the diameter of which decreases from the air cleaner 12-side toward the surge tank 14-side, the first inner pipe member 31 has the maximum diameter at the end portion 311 on an intake side of the first inner pipe member 31, that is, on the air cleaner 12-side. The diameter of the first inner pipe member 31 at the end portion 311 on the air cleaner 12-side is larger than that at the end portion 312 on the small-diameter side of the first inner pipe member 31, the end portion 312 being opposed to the second inner pipe member 32. A difference in a cross-sectional area between the air cleaner 12 and the end portion 311 of the first inner pipe member 31 is smaller than a difference in a cross-sectional area between the air cleaner 12 and the end portion 321 on the small-diameter side of the second inner pipe member 32 if the air cleaner 12 is joined to the end portion 321. Therefore, sudden change in the cross-sectional area between the air cleaner 12 and the first inner pipe member 31 is decreased. Accordingly, a pressure loss of air flowing from the air cleaner 12 into the first inner pipe member 31 is decreased, as compared to that of air flowing from the air cleaner 12 directly into the end portion 321 on the small-diameter side of the second inner pipe member 32.

As described above, the first inner pipe member 31 and the second inner pipe member 32 are formed in a tubular manner like a truncated cone. The first inner pipe member 31 and the second inner pipe member 32 have their respective maximum inside and outside diameters at both end sides of the intake passage 22. Consequently, the inner pipe member 30, which includes the first inner pipe member 31 and the second inner pipe member 32, has a constricted drum shape from its both ends toward central portion along its axial direction. By providing the outer pipe member 40 on an outer circumferential side of this drum-shaped inner pipe member 30, a space, which serves as a resonator 50, is formed between the outer pipe member 40 and the inner pipe member 30. The resonator 50 communicates with the intake passage 22 through the gap formed in an area, in which the first inner pipe member 31 is opposed to the second inner pipe member 32. Accordingly, the space formed between the outer pipe member 40 and the inner pipe member 30 serves as the resonator 50, which increases volume of the intake passage 22. Thus, the sound of intake air is reduced not only by the diffuser effect of the second inner pipe member 32 but also by the resonator 50, volume of which is relatively large.

The maximum diameter of the inner pipe member 30 (i.e., the diameter of the first inner pipe member 31 at the end portion 311 on the large-diameter side of the first inner pipe member 31, and the diameter of the second inner pipe member 32 at the end portion 322 on the large-diameter side of the second inner pipe member 32) is the approximately the same as a maximum diameter of the outer pipe member 40. As a result, the resonator 50 formed between the outer pipe member 40 and the inner pipe member 30 is a space enclosed with the both ends of the intake passage 22 in its axial direction. In the first embodiment, in particular, the inner pipe member 30 and the outer pipe member 40 are set to have approximately the same maximum diameter. Thus, the resonator 50 is formed on an outer circumferential side of the constricted part of the inner pipe member 30. Consequently, even though the resonator 50 is formed on the outer circumferential side of the inner pipe member 30, a maximum diameter of the intake pipe portion 20 is approximately the same as the maximum diameter of the inner pipe member 30, and thereby projection of members into the outer circumferential side of the inner pipe member 30 is reduced. Furthermore, the first inner pipe member 31 is opposed to the second inner pipe member 32 with the gap formed at the central portion of the inner pipe member 30 along its axial direction. Thus, an intake air noise of intake air flowing in the intake passage 22 is effectively diffused from the gap between the first inner pipe member 31 and the second inner pipe member 32 into the resonator 50.

As described above, in the first embodiment, the second inner pipe member 32 is formed in a tubular manner like a truncated cone, and the diameter of the second inner pipe member 32 gradually increases from the air cleaner 12-side toward the surge tank 14-side. Accordingly, the intake air noise of air, which flows in the intake passage 22 formed from the second inner pipe member 32, is reduced by the diffuser effect of the intake passage 22 formed from the second inner pipe member 32. Hence, the intake air noise can be reduced in a broad frequency range.

In the first embodiment, by forming the first inner pipe member 31 and the second inner pipe member 32 in a tubular manner like a truncated cone, the diameter of the first inner pipe member 31 at the end portion on the air cleaner 12-side and the diameter of the second inner pipe member 32 at the end portion on the surge tank 14-side are made large. Accordingly, changes in cross-sectional areas of the intake passage 22 between the air cleaner 12 and the first inner pipe member 31, and between the second inner pipe member 32 and the surge tank 14 are decreased. As a result, the pressure loss caused by the sudden change in the cross-sectional area can be reduced, thereby improving output of the engine 13.

In the first embodiment, moreover, the outer pipe member 40 is provided on the outer circumferential side of the inner pipe member 30, which has the constricted part at its central portion along its axial direction. The resonator 50 is formed between the inner pipe member 30 and the outer pipe member 40. Particularly by setting the inner pipe member 30 and the outer pipe member 40 to have approximately the same maximum diameter, even though the resonator 50 is formed on the outer circumferential side of the inner pipe member 30, the projection of members into the outer circumferential side of the inner pipe member 30 is reduced. Therefore, the air-intake apparatus 11 can be easily installed to the engine 13 without causing upsizing, and the intake air noise can be reduced by the resonator 50.

### Second Embodiment

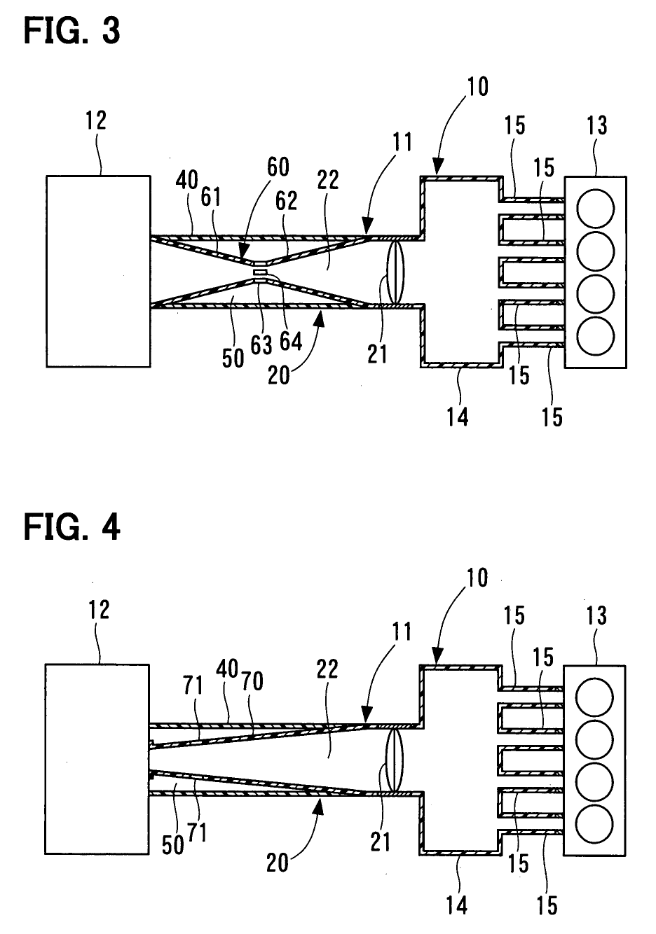

FIG. 3 shows an air-intake system, to which an air-intake apparatus according to a second embodiment of the present invention is applied.

In the second embodiment, an inner pipe member 60 is formed from one member. That is, the inner pipe member 60 has a first pipe portion 61, a second pipe portion 62, and a small diameter portion 63. The small diameter portion 63 is provided at a central portion of the inner pipe member 60 along its axial direction. The inner pipe member 60 has the first pipe portion 61 from an end portion of the inner pipe member 60 on an air cleaner 12-side toward the small diameter portion 63, and the second pipe portion 62 from the small diameter portion 63 toward an end portion of the inner pipe member 60 on a surge tank 14-side.

The first pipe portion 61 is formed in a tubular manner like a truncated cone, a diameter of which gradually decreases from its end portion on the air cleaner 12-side toward the small diameter portion 63. The second pipe portion 62 is formed in a tubular manner like a truncated cone, a diameter of which gradually increases from the small diameter portion 63 toward its end portion on the surge tank 14-side. Consequently, the inner pipe member 60 is formed by forming the first pipe portion 61, the second pipe portion 62, and the small diameter portion 63 from one member.

A communicating hole 64 is formed on the small diameter portion 63 of the inner pipe member 60. At least one communicating hole 64 is formed in a circumferential direction of the inner pipe member 60. The communicating hole 64 penetrates through the small diameter portion 63 from its inner circumferential wall to outer circumferential wall. Accordingly, an intake passage 22 formed from the inner pipe member 60 is communicated with a resonator 50 formed between the inner pipe member 60 and an outer pipe member 40, through the communicating hole 64. As a result, the sound of intake air flowing in the intake passage 22 is effectively diffused into the resonator 50. Thus, the sound of intake air is further reduced.

### Third Embodiment

FIG. 4 shows an air-intake system, to which an air-intake apparatus according to a third embodiment of the present invention is applied.

In the third embodiment, a diameter of an inner pipe member 70 increases from its end portion on an air cleaner 12-side toward the other end portion on a surge tank 14-side. That is, an air-intake apparatus 11 has only a member corresponding to the second inner pipe member 32, and does not have a member corresponding to the first inner pipe member 31 in the first embodiment. A sound of intake air flowing in an intake passage 22 is reduced in a broad frequency range by the diffuser effect of the inner pipe member 70, the diameter of which increases from the air cleaner 12-side toward the surge tank 14-side. Accordingly, by providing the inner pipe member 70, which has a shape of the third embodiment, the intake air noise is reduced.

An outer circumferential side of the inner pipe member 70 is covered with an outer pipe member 40. Consequently, a resonator 50 is formed between the inner pipe member 70 and the outer pipe member 40. The inner pipe member 70 has a communicating hole 71, which penetrates through a sidewall of the inner pipe member 70 to communicate between its outer circumferential side and inner circumferential side, on a part of the inner pipe member 70 along its axial direction. As a result, the intake passage 22 is communicated with the resonator 50 through the communicating hole 71. Therefore, the sound of intake air flowing in the intake passage 22 is reduced by the diffuser effect of the inner pipe member 70, and also by the resonator 50 between the inner pipe member 70 and the outer pipe member 40. So in the third embodiment as well, the intake air noise can be reduced in a broad frequency range.

In the third embodiment, the inner pipe member 70 and the outer pipe member 40 have approximately the same maximum diameter. Thus, even when the resonator 50 is formed between the inner pipe member 70 and the outer pipe member 40, members projecting into the outer circumferential side of the inner pipe member 70 can be limited. Accordingly, the air-intake apparatus 11 can be easily installed to an engine 13 without causing upsizing.

### Other Embodiments

In the first embodiment described above, the first inner pipe member 31 and the second inner pipe member 32 of the inner pipe member 30 have approximately the same entire length along an axial direction of the inner pipe member 30. Likewise, in the second embodiment, the first pipe portion 61 and the second pipe portion 62 have approximately the same entire length along an axial direction of the inner pipe member 60. Nevertheless, the first inner pipe member 31 and the second inner pipe member 32 may have different lengths, and the first pipe portion 61 and the second pipe portion 62 may have different lengths.

In the above embodiments, the air cleaner 12 is attached to the end portion of the air-intake apparatus 11. However, the air cleaner 12 may not be attached as the occasion demands.

Furthermore, in the above embodiments, the maximum diameters of the inner pipe members 30, 60, 70 and the maximum diameter of the outer pipe member 40 are approximately the same. Nevertheless, the maximum diameter of the outer pipe member 40 may be smaller than those of the inner pipe members 30, 60, 70. Conversely, the maximum diameter of the outer pipe member 40 may be larger than those of the inner pipe members 30, 60, 70. In this case, although upsizing of the air-intake apparatus 11 is caused as compared to the above embodiments, members do not locally project, so that the air-intake apparatus 11 is not prevented very much from being installed. Also, by making the maximum diameter of the outer pipe member 40 larger than those of the inner pipe members 30, 60, 70, volume of the resonator 50 is increased, and thereby intake air noise reduction performance can be improved.

The present invention described above is not by any means limited to the above embodiments, and it can be applied to various embodiments without departing from the scope of the invention.

Additional advantages and modifications will readily occur to those skilled in the art. The invention in its broader terms is therefore not limited to the specific details, representative apparatus, and illustrative examples shown and described.

What is claimed is:

1. An air-intake apparatus comprising:
an inner pipe member, which defines an intake passage that connects an inlet and a surge tank, wherein a diameter of the inner pipe member gradually increases when the inner pipe member extends toward a surge tank-side end portion of the inner pipe member, the surge tank-side end portion being connected to the surge tank; and
an outer pipe member, which covers an outer circumferential side of the inner pipe member and defines a resonator between the outer pipe member and the inner pipe member, the resonator communicating with the intake passage.

2. The air-intake apparatus according to claim 1, wherein the inner pipe member includes a small diameter portion, a first pipe portion, and a second pipe portion, wherein:
the small diameter portion is located between the surge tank-side end portion and an inlet-side end portion of the inner pipe member, and the inlet-side end portion is connected to the inlet;
the first pipe portion extends from the inlet-side end portion to the small diameter portion, and an inside diameter and an outside diameter of the first pipe portion gradually decrease when the first pipe portion extends from the inlet-side end portion toward the small diameter portion; and
the second pipe portion extends from the small diameter portion to the surge tank-side end portion, wherein an inside diameter and an outside diameter of the second pipe portion gradually increase when the second pipe portion extends from the small diameter portion toward the surge tank-side end portion.

3. The air-intake apparatus according to claim 2, wherein the inner pipe member has a communicating hole at the small diameter portion of the inner pipe member, and the intake passage is communicated with the resonator through the communicating hole.

4. The air-intake apparatus according to claim 1, wherein the inner pipe member has a first inner pipe member, which has an inlet-side end portion that is connected to the inlet and a first end portion that is opposite from the inlet-side end portion, and a second inner pipe member, which has an surge tank-side end portion that is connected to the surge tank and a second end portion that is opposite from the surge tank-side end portion, wherein:
the second end portion is opposed to the first end portion with a predetermined distance therebetween;
an inside diameter and an outside diameter of the first inner pipe member gradually decrease when the first inner pipe member extends from the inlet-side end portion toward the first end portion; and
an inside diameter and an outside diameter of the second inner pipe member gradually increase when the second inner pipe member extends from the second end portion toward the surge tank-side end portion.

5. The air-intake apparatus according to claim 1, wherein the inner pipe member and the outer pipe member have approximately the same maximum diameter.
